(19) United States
(12) Patent Application Publication
(10) Pub. No.: US 2012/0069054 A1
(43) Pub. Date: Mar. 22, 2012

(54) ELECTRONIC DISPLAY SYSTEMS HAVING MOBILE COMPONENTS

(75) Inventors: Douglas MacDonald, Dawsonville, GA (US); Peter W. Hildebrandt, Duluth, GA (US); Dale Miller, Snelville, GA (US); William Christopher Pollitt, Marietta, GA (US); Robert J. Hawkins, Hillsboro, OR (US); Michael Boyle, Dacula, GA (US)

(73) Assignee: Polyvision Corporation, Suwanee, GA (US)

(21) Appl. No.: 13/320,742

(22) PCT Filed: May 12, 2010
(86) PCT No.: PCT/US10/34580

§ 371 Date: Nov. 15, 2011

Related U.S. Application Data
(60) Provisional application No. 61/178,794, filed on May 15, 2009.

(51) Int. Cl. G09G 5/00

(52) U.S. Cl. 345/676

(57) ABSTRACT

Electronic display systems include mobile units for remotely modifying a displayed image. An electronic display system can include a display surface, a processing device, a mobile unit, and an input device. The display surface can receive and display an image rendered by the processing device. The display image on the display surface can be modified through interaction of the input device and the mobile unit. The input device can sense its position relative to the mobile unit and can transmit data relating to its position to the processing device. The processing device can interpret the position data as operations on the displayed image. Accordingly, the processing device can modify the displayed image on the display surface based on interactions between the input device and the mobile unit.

### CROSS-REFERENCE TO RELATED APPLICATION

This application claims a benefit, under 35 U.S.C. §119(e), of U.S. Provisional Application Ser. No. 61/178,794, filed 15 May 2009, the entire contents and substance of which are hereby incorporated by reference.

### BACKGROUND

Various aspects of the present invention relate to electronic display systems and, more particularly, to electronic display systems having mobile components, mobile units for electronic display systems, and methods for using same.

Conventional electronic writing systems come in various forms, for example, pen and paper systems and electronic whiteboard systems. While conventional electronic writing systems are useful in various environments, conventional systems generally limit writing and drawing to a user positioned at a primary whiteboard surface. As a result, conventional systems do not enable a remote user to modify content displayed by the writing systems.

A conventional whiteboard system generally includes a whiteboard surface, a processing device, and a projector. The processing device is in communication with the projector, which is directed at the whiteboard surface. A user drives the processing device by touching the whiteboard surface, and draws on the whiteboard surface by moving a pen across the surface. Such movement is captured by some form of capturing means, and data describing the movement is communicated to the processing device. The processing device then determines a new output of the projector based on the pen's movement across the whiteboard surface. The new output is communicated to the projector for display on the whiteboard surface.

A number of drawbacks exist in conventional whiteboard systems. For example, when a user writes on the whiteboard surface, the user's body will generally block a portion of the projected display, such that the entire output of the projector is not visible on the whiteboard surface. Additionally, in a classroom or group setting, each participant must approach the whiteboard surface to contribute to the displayed content on the whiteboard surface.

In contrast, pen and paper systems are designed for personal use. Handwriting on paper can be digitized by determining how a pen is moved across the paper. Determining positioning can be facilitated by providing a position-coding pattern on the surface of the paper, where the pattern codes coordinates of points on the paper. The pen can be provided with a sensor for recording the position-coding pattern locally at the tip of the pen as the pen contacts the paper's surface. The pen or a separate processing system can decode the recorded position-coding pattern by analyzing the portion of the pattern viewed by the camera. As a result, movement of the pen across the surface can be determined as a series of coordinates.

Data describing the movement of the pen across the paper is stored in the pen or external storage device for immediate or future use. The data can be wirelessly transmitted for storage on another device, or can be directly downloaded from the pen to a local computer device. At the time the pen is moved across the paper, however, only the user of the pen has a convenient view of what is being drawn or written on the paper. Unlike an electronic whiteboard, the pen and paper system is a personal writing system for writing and viewing by a single person.

### SUMMARY

Briefly described, various embodiments of the present invention are electronic display systems having mobile components, mobile units for electronic display systems, and methods for using same. According to some exemplary embodiments of the present invention, an electronic display system can enable users to modify a display without approaching the display. One or multiple users viewing the display can modify the display from remote locations. The electronic display system can comprise a display surface, a mobile unit, an input device, a processing device, and a projector.

The display surface can receive markings or images from users, the input device, the projector, or a combination of these. In an exemplary embodiment of the electronic display system, the display surface can be a passive component. For example and not limitation, the display surface can be a non-electronic surface, such as a whiteboard. The display surface can receive physical markings or touches from a user, and can also present images projected onto the display surface. A position-coding pattern can be provided on the display surface to assist the input device in sensing its position relative to the display surface. The pattern can encode coordinates of the display surface, which can be detected by the input device.

The mobile unit can enable a user of the display system to modify the display on the display surface without approaching the display surface. A user of the display system can utilize the input device in conjunction with the mobile unit. The mobile unit can comprise a receiving surface for receiving an interaction from the user. The receiving surface can have similar properties as the display surface. For example, like the display surface, the receiving surface of the mobile unit can incorporate a position-coding pattern. Accordingly, when the input device interacts with the mobile unit, it can sense its position relative to the receiving surface of the mobile unit.

The input device can detect an indication of its position with respect to a surface, such as the display surface or the receiving surface of the mobile unit. The input device can comprise a sensing device, such as a camera. With the sensing device, the input device can detect an indication of its position, for example by capturing one or more images of a local portion of a position-coding pattern on the display surface or the receiving surface of the mobile unit. The input device can transmit indication of its own movements to the processing device for real time or future interpretation.

The processing device is configured to receive position data relating to a position of the input device, and to map such data to one or more operations and target coordinates on the display surface. The processing device can interpret movement of the input device on or near the display surface, or the receiving surface of the mobile unit, as performance of one or more operations on the display surface. For example, the processing device can determine how to update an old image displayed on the display surface. The processing device can render a new display image based on the old image, coordinates of the input device, and a current operating mode. The processing device can then transmit the new image to the projector for display onto the display surface.

The projector can project one or more display images onto the display surface based on instructions from the processing device. Accordingly, the display surface can be modified based on interaction of the input device with the display surface or the mobile unit.

These and other objects, features, and advantages of the electronic display system will become more apparent upon reading the following specification in conjunction with the accompanying drawing figures.

### BRIEF DESCRIPTION OF THE FIGURES

FIG. 1 illustrates an electronic display system, according to an exemplary embodiment of the present invention.

FIG. 2 illustrates a dot pattern on a display surface of the electronic display system, according to an exemplary embodiment of the present invention.

FIG. 3 illustrates a mobile unit of the electronic display system, according to an exemplary embodiment of the present invention.

FIG. 4 illustrates an exploded perspective view of layers of the mobile unit, according to an exemplary embodiment of the present invention.

FIG. 5A illustrates a frame of the mobile unit, according to an exemplary embodiment of the present invention.

FIG. 5B illustrates a backing of the mobile unit, according to an exemplary embodiment of the present invention.

FIG. 6A illustrates a partial cross-sectional side view of an input device with a secured cap, according to an exemplary embodiment of the present invention.

FIG. 6B illustrates a partial cross-sectional side view of the input device with the cap removed, according to an exemplary embodiment of the present invention.

FIG. 7A illustrates a close-up partial cross-sectional side view of a portion of the input device, according to an exemplary embodiment of the present invention.

FIG. 7B illustrates a partial cross-sectional side view of the input device, according to an exemplary embodiment of the present invention.

FIGS. 8A-8B illustrate images of the dot pattern of FIG. 2, as captured by a sensing device of the input device, according to an exemplary embodiment of the present invention.

FIG. 9 illustrates a flow chart of a method of receiving and processing input from the mobile unit of the electronic display system, according to an exemplary embodiment of the present invention.

FIG. 10 illustrates a system of use of the mobile unit in the electronic display system, according to an exemplary embodiment of the present invention.

### DETAILED DESCRIPTION

To facilitate an understanding of the principles and features of the invention, various illustrative embodiments are explained below. In particular, the invention is described in the context of being an electronic whiteboard system having one or more mobile units. Embodiments of the invention, however, are not limited to electronic whiteboard systems. Rather, embodiments of the invention can comprise various electronic display systems and mobile units for use with such systems.

The materials and components described hereinafter as making up various elements of the invention are intended to be illustrative and not restrictive. Many suitable materials and components that would perform the same or similar functions as the materials and components described herein are intended to be embraced within the scope of the invention. Other materials and components not described herein can include, but are not limited to, for example, analogous materials and components developed after development of the invention.

Various embodiments of the present invention are mobile units for electronic display systems and electronic display systems incorporating mobile components, such as the mobile units. An electronic display system incorporating the mobile unit can be the same or similar to those described in U.S. patent application Ser. Nos. 12/138,759 and 12/138,933, both filed 13 Jun. 2008. Such patent applications are herein incorporated by reference as if fully set forth below.

Referring now to the figures, in which like reference numerals represent like parts throughout the views, embodiments of the electronic display system and mobile unit will be described in detail.

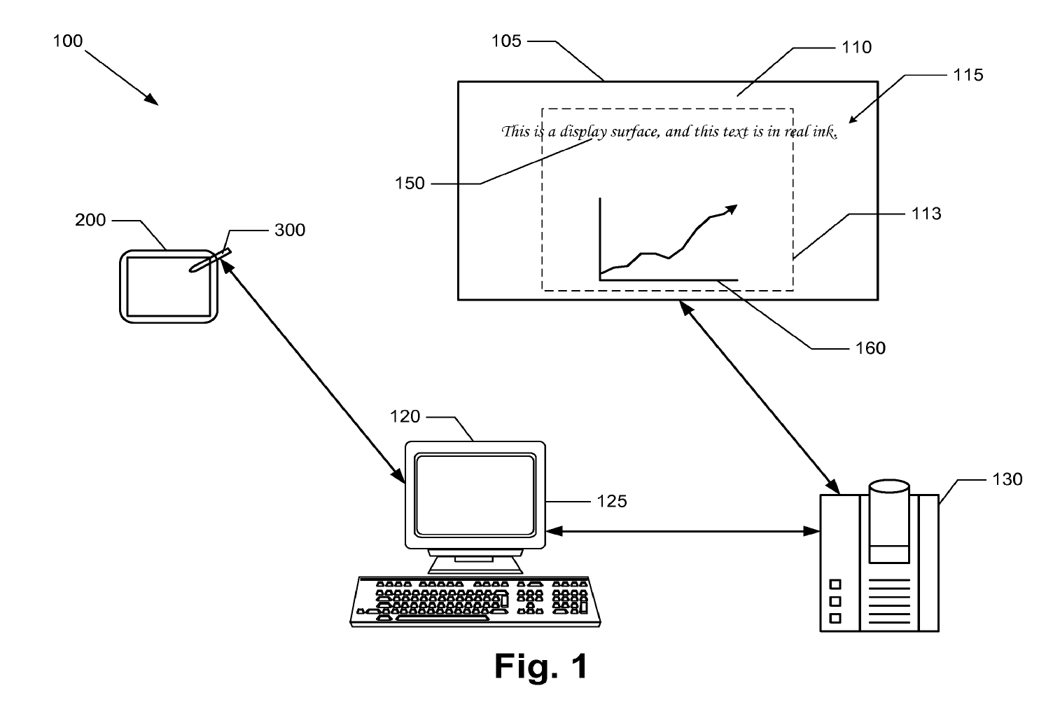

FIG. 1 illustrates an electronic display system according to an exemplary embodiment of the present invention. As shown in FIG. 1, an exemplary electronic display system 100 can comprise a display device 105, a processing device 120, projector 130, a mobile unit 200, and an input device 300.

### A. The Display Device

The display device 105 can be a panel, screen, or other device having a display surface 110 for receiving a combination of physical markings and touches. Those physical markings and touches can combine with projected images to create an overall display image 115 on the display surface 110. The display image 115 can comprise a combination of various objects visible on the display surface 110, including physical objects, a projected image 113, and other digital representations of objects. In other words, the display image 115 is what a user can see on the display surface 110. In contrast the complete display image 115, a projected image 113 can comprise an image projected onto the display surface 110, while the display image 115 can include one or more projected images 113, as well as physical markings made on the display surface 110. In an exemplary embodiment of the electronic display system 100, the display image 115 can be modified through use of the input device 300, which can interact with the mobile unit 200 or directly with the display surface 110.

The complete display image 115 on the display surface 110 can comprise both real ink 150 and virtual ink 160. The real ink 150 can comprise markings, physical and digital, generated by the input device 300 and other marking implements. As shown in FIG. 1, because real ink 150 can comprise physical markings on the display surface 110, real ink 150 need not be contained within the projected image 113. The virtual ink 160 can comprise other objects projected, or otherwise displayed, onto the display surface 110 in the projected image 113. These other objects can include, without limitation, a graphical user interface or a virtual window of an application running on the display system 100. Real ink 150 and virtual ink 160 can overlap, and consequently, real ink 150 can be used to annotate objects appearing in virtual ink 160.

The display device 105 can be a passive component. For example and not limitation, the display device 105 can be a non-electronic device, such as a whiteboard having no internal electronics, and the display surface 110 can be a non-electronic surface Like a conventional whiteboard, the display device 105 can be composed of ceramic-steel, having a ceramic layer in front of a steel layer. The display surface 100 can be a face of the ceramic layer. In some alternate exemplary embodiments, however, the display device 105 can be an electronic display device comprising various internal electronics components enabling the display surface 110 to actively display markings or images.

A position-coding pattern 400 can be provided on the display surface 110. The pattern 400 can enable the input device 300 to sense an indication of its position on the display surface 110 by viewing or otherwise sensing a local portion of the pattern 400. The implemented pattern 400 can indicate the position of the input device 300 relative to a previous position, or can indicate an absolute position of the input device 300 in the coordinate system of the display surface 110. Various images can be used for the pattern 400. For example, the pattern 400 can comprise a known image, which can include alphanumeric characters, a coding pattern, or many other discernable patterns of image data capable of indicating relative or absolute position.

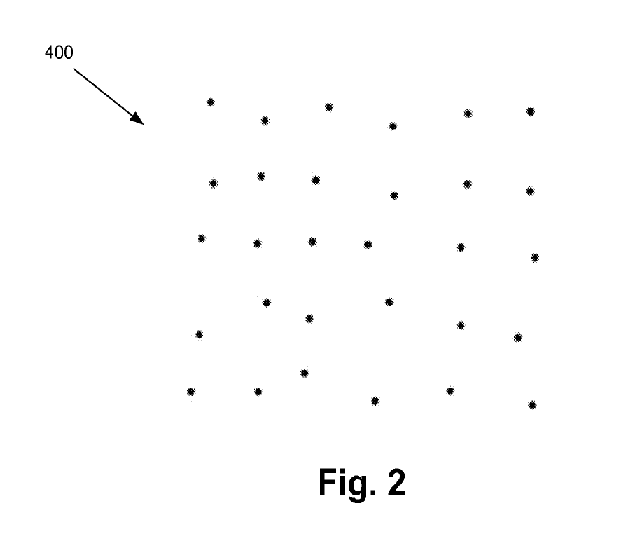

In an exemplary embodiment of the display surface 110, the position-coding pattern 400 can be a dot matrix position-coding pattern, or dot pattern, such as that illustrated in FIG. 2. The pattern 400 can encode coordinates of positions on the display surface 110. A pattern 400 on the display surface 110 can be designed to provide indication of an absolute position of the input device 300 in a coordinate system of the display surface 110. When the input device 300 acts directly on the display surface 110, the input device 300 can obtain position data by capturing one or more images of a portion of the pattern 400 on the display surface 110. The input device 300 or the processing device 120 can then decode the position data. As a result, movement of the input device 300 across the display surface 110 can be determined as a series of coordinates on the display surface 110.

The pattern 300 can, but need not, be detectable by the human eye. Preferably, the pattern 300 is not so noticeable as to distract a viewer of the display surface 110 from markings or images displayed on the display surface 110. For example, in an exemplary embodiment, the display surface 110 can appear to have a uniform, light grey color.

In some embodiments, calibration can be required for accurate use of the display surface 110. For example, a passive display surface 110 cannot detect positioning of an image projected onto the display surface 110 by the projector 130. When a user seeks to modify a specific portion of the display surface 110 by using the input device 300 on such portion, it can be difficult or impossible to determine how to project such modifications onto the display surface 110 at coordinates corresponding to the user's interaction. Consequently, some embodiments of the display surface 110 can require calibration.

Calibration can involve, for example, the user's complying with one or more requests to touch the display surface 110 with the input device 300 at positions with known coordinates in the coordinate system of an image projected onto the display surface 110. For example, the user can be instructed to touch two opposite corners of a projected image 113. Because the input device 300 can identify the coordinates of the touched points on the display surface 110, by detecting the pattern 400 on the display surface 400, the display system 100 can determine a mapping between coordinate systems of the projected image 113 and the display surface 110. For further interactions between the input device 300 and the display surface 110, coordinates of the input device on the display surface 110 can be correctly mapped to coordinates of the input device 300 on the projected image 113. Thus, operations performed by the input device can be properly rendered and projected onto the display surface 110 in the projected image 113, to become a part of the total display image 115.

### B. The Mobile Unit

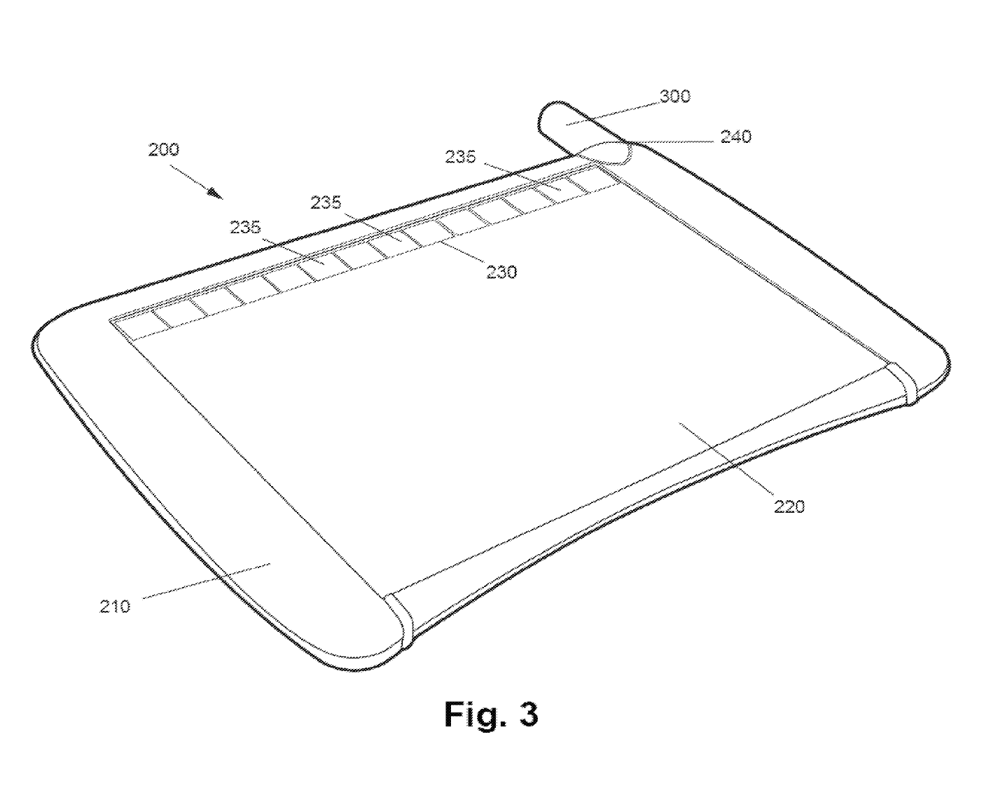

FIG. 3 illustrates an exemplary embodiment of the mobile unit 200. In some exemplary embodiments of the display system 100, as described in detail herein, the mobile unit 200 can be a non-electronic companion to the display surface 110 and the larger electronic display system 100 depicted in FIG. 1. Alternatively, however, the mobile unit 200 can be a stand-alone, personal electronic display system. For example, in some embodiments, the mobile unit 200 can comprise internal electronics for displaying physical representations of digital objects.

The mobile unit 200 can act as a remote unit for modifying the display image 115 on the display surface 110. In a conventional whiteboard system or other conventional display system, each user must approach a display surface and interact directly with the display surface to enable a group of people to view the user's modifications of a display. In contrast, the mobile unit 200 can enable a user's modifications to the display image 115 to be viewable on the display surface 110 without the user having to approach the display surface 110.

In an exemplary embodiment of the display system 100, the same input device 300 that is usable on the display surface 110 can also be usable with the mobile unit 200. According to embodiments of the present invention, a user can use the input device 300 in conjunction with either the mobile unit 200 or directly with the display surface 110. Points on a receiving surface 220 of the mobile unit 200 can map to points on the projected image 113 and, thus, to points on the display image 115 appearing on the display surface 110. Accordingly, the display image 115 can be modified by operations performed with the input device 300 on the display surface 110, as well as by operations performed with the input device 300 on the mobile unit 200.

For example, in a lecture or other one-to-many presentation setting, the lecturer can move throughout a room while modifying the display image 115 with the mobile unit 200. To encourage group interaction, multiple mobile units 200 can be dispersed throughout the room. Group participants can modify the display image 115 through their mobile units 200. In some embodiments, a group leader can activate or deactivate participants' mobile units 200 via the input device 300 to, respectively, enable or disable modification of the display image 115 from that particular mobile unit 200. Additionally, or alternatively, each mobile unit 200 can have its own activation and deactivation actuator.

Although the mobile unit 200 is described in the context of its use in various embodiments of an electronic display system 100, use of the mobile unit 200 need not be limited to the embodiments described. The mobile unit 200 can be useable with other, or multiple, electronic display systems. For example, in some instances, the mobile unit 200 can be used with a first electronic display system 100, where touches from a stylus on the display surface 110 or sensed by a camera, while in other instances, the same mobile unit 200 can be used in an electronic display system 200 having a display surface 110 integrating resistive membrane technology. The mobile unit 200 need not be limited to a particular type of electronic display system 100.

As illustrated in FIG. 3, the mobile unit 200 can comprise a body 210, a receiving surface 220, a function strip 230, and an input device holder 240.

The body 210 can provide structural support for the mobile unit 200. The body 210 can be composed of many materials that can provide a structure for the mobile unit 200. For example, the body 210 can be plastic, metal, resin, or a combination thereof. A material of the body 210 can be an anti-microbial material, or can be treated with an anti-microbial chemical, to minimize the spread of bacteria that could result by various users holding and using the mobile unit 200. Because the mobile unit 200 can preferably be carried by a human user, the body 210 can be sized for personal use and ergonomically designed for a user's comfort. In an exemplary embodiment of the mobile unit 200, the body 210 and other components of the mobile unit 200 are designed such that the mobile unit 200 is lightweight. In some embodiments, the weight of the mobile unit 200 does not exceed approximately two pounds, and the surface area of the receiving surface 220 does not exceed approximately two square feet.

The receiving surface 220 can receive indications of operations on the display image 115 as provided by the input device 300. In some exemplary embodiments, like the display surface 110, the receiving surface 220 and the overall mobile unit 200 can be passive devices, which need not include batteries, cords, or cables for its operation. For example and not limitation, the receiving surface 220 can be a front surface of a non-electronic panel, such as a whiteboard, which can be composed of a ceramic-steel material. In some alternate exemplary embodiments, however, the receiving surface 220 can be an electronic display device comprising various internal electronics components enabling the receiving surface 220 to display digital representations of markings or images.

The receiving surface 220 can be capable of receiving physical markings from the input device 300 or other marking implement. For example and not limitation, the receiving surface 220 can comprise a whiteboard panel or a paper material. If paper is provided for the receiving surface, the paper can be replaceable to enable a user to have a clean piece of paper when desirable. In alternate embodiments, however, the receiving surface 220 need not be capable of receiving physical markings.

Physical markings or other operations of the input device 300 on the receiving surface 220 can be translated into operations performed on the display surface 110, and can thereby appear in the display image 115 in some form. If the input device 300 provides physical markings on the receiving surface 220, then those physical markings can appear on the receiving surface 200 until erased or otherwise removed. The entire display image 115 need not appear on the mobile unit 200, as unlike the display surface 110 maintaining the display image 115, the mobile unit 200 may not receive projected images 113 to complete its display.

A position-coding pattern 400 can be provided on the receiving surface 220 to indicate relative or absolute coordinates on the receiving surface 220. Like the display surface 110, the receiving surface 220 can incorporate various images for the position-coding pattern 400. For example and not limitation, the position-coding pattern can be or comprise a dot pattern, such as the dot pattern illustrated 400 of FIG. 2. The pattern 400 can encode coordinates of points on the receiving surface 220, and because those points can correspond to points in the projected image 113, the pattern 400 on the receiving surface 400 can likewise encode points on the projected image 113, the display image 115, and the display surface 110. In some embodiments, the pattern 400 on the receiving surface 220 can be designed to provide indication of an absolute position of the input device 300 in a coordinate system of the receiving surface 220, which can map to absolute coordinates on the projected image 113, the display image 115, and the display surface 110. As described in detail below, the input device 300 can obtain position data by capturing one or more images of a portion of the pattern 400. The input device 300 or the processing device 120 can then decode such position data. As a result, movement of the input device 300 across the receiving surface of the mobile unit 200 can be determined as a series of coordinates on the receiving surface 220.

The pattern 400 can, but need not, be detectable by the human eye. Preferably, the pattern 400 is not so noticeable as to distract a viewer of the receiving surface 220 from other markings on the receiving surface 220. For example, in an exemplary embodiment, the receiving surface 220 can appear to have a uniform, slightly grayish color.

In an exemplary embodiment of the mobile unit 200, calibration is not required for proper mapping of coordinates on the receiving surface 220 to coordinates in a projected image 113 on the display surface 110. The electronic display system 100 can automatically map the full receiving surface 220 to the full projected image 113. As a result, coordinates of the receiving surface 220 can be automatically scaled to coordinates of the projected image 113. For example, a point in the top left corner of the receiving surface 220 can be projected at the top left corner of the projected image 113. Analogously, a point at the bottom right corner of the receiving surface 220 can be projected at the bottom right corner of the projected image 113.

The function strip 230 can enable a user to select a function, or mode of operation, for the input device 300. For example and not limitation, the function strip 230 can include function indicators 235, or function selectors, for the following: hover, cursor select, next, previous, keyboard, pen palate, various pen colors (e.g., black, red, green, blue), various pen sizes (e.g., small, medium, large), small eraser, large eraser, erase all, print, save, and other operations or features. In some exemplary embodiments, a “hover” function need not be used exclusively and can be combined with other functions. For example, when the input device 300 is proximate the receiving surface 220, the user can “hover” to view the position of the input device 300 on the display surface 110 when performing some other operation with the input device 300, wherein the projected image 113 on the display surface 110 can be modified to indicate the translated position of the input device 300 on the display surface 110. The hover function can require the input device 300 to be in contact with the receiving surface 220, or in some embodiments, the hover function can perform properly when the input device 300 is sufficiently near the receiving surface 220. Accordingly, although the receiving surface 220 does not necessarily present the same image as the display surface 110, the user can use the hover function to properly position the input device 300 on the receiving surface 220 to operate at a desired position on the display surface 110.

In an exemplary embodiment, a position-coding pattern 400 is associated with the function strip 230. For example, each function indicator 235 can be located at a known position on the receiving surface 220. The function strip 230 can be on top of the pattern 400 of the receiving surface 220, such that the underlying pattern 400 is detectable by the input device 300. Because the input device 300 can detect its position based on the pattern 400, the display system 100 can determine a function indicator 235 selected by the input device 300. Alternatively, the pattern 400 can be integrated into the function strip 230, and each function indicator 235 can be associated with a known portion of the pattern 400. Accordingly, when the input device 300 detects a portion of the pattern 400 associated with a particular function indicator 235, the display system 100 can correctly identify the function indicator 235. Additionally, in some embodiments, the function strip 230 can be releasably secured to the mobile unit 300, such that the function strip 230 can be relocated about or outside of the receiving surface 220 for the user's convenience.

After the user selects a function indicator 235, further interaction between the input device 300 and the mobile unit 200 can be interpreted as performance of the selected function. For example, if the selected function indicator 235 represents small pen size, then further interaction of the input device 300 with the mobile unit 200 can result in markings of a small pen size being projected onto the display surface 110.

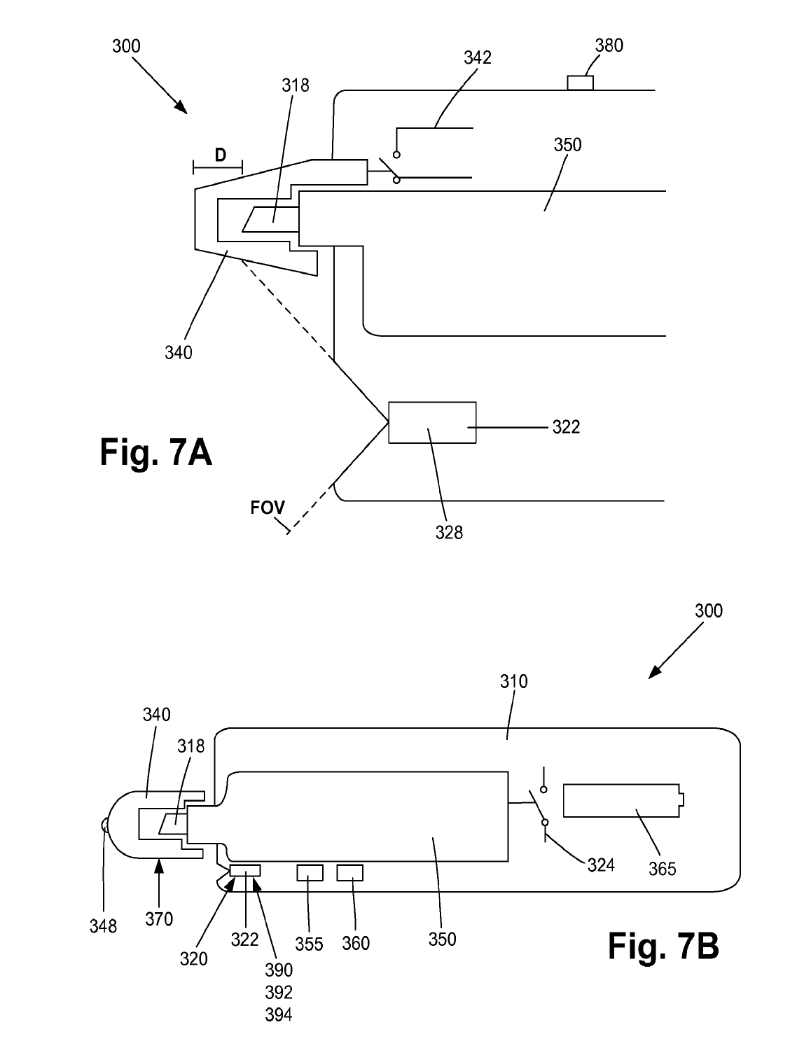

As also illustrated in FIG. 3, the mobile unit 200 can further include an input device holder 240. The input device holder 240 can hold the input device 300 when it is not in use. In an exemplary embodiment, insertion into the input device holder 240 can cause the input device 300 to power down or off. For example, an actuator 380 (see FIG. 7A) on the input device 300 can depress when the input device 300 is inserted into the holder 240, thereby powering down in the input device 300. Although FIG. 3 illustrates the input device holder 240 as being a receptacle in the mobile unit 200, this need not be the case. For example, the input device holder 240 can comprise a clamp on the underside of the mobile unit 200, or many other components or cutouts for retaining the input device 300.

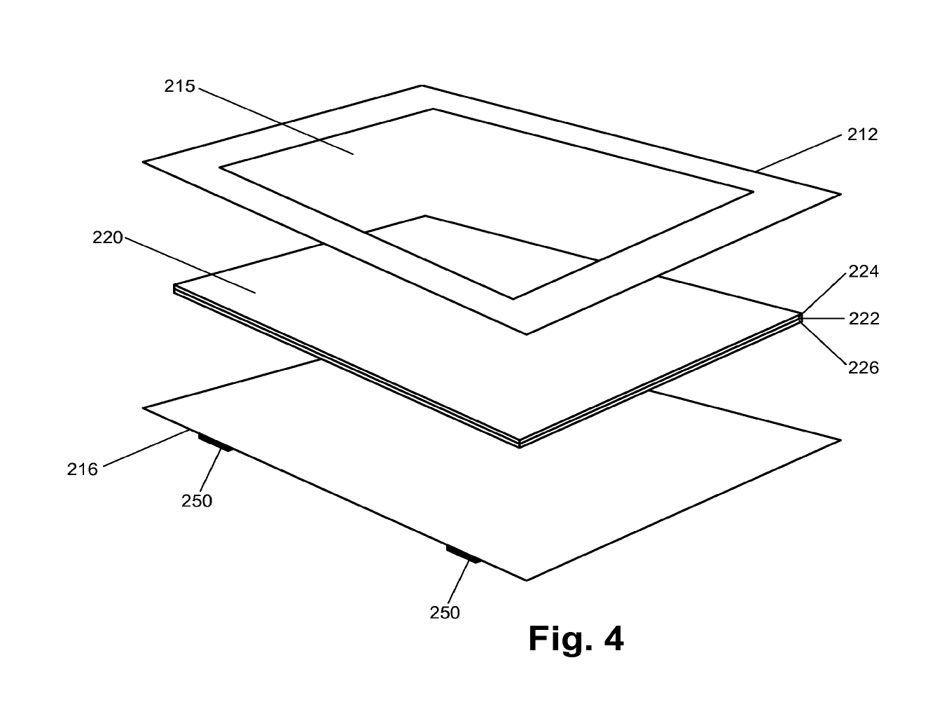

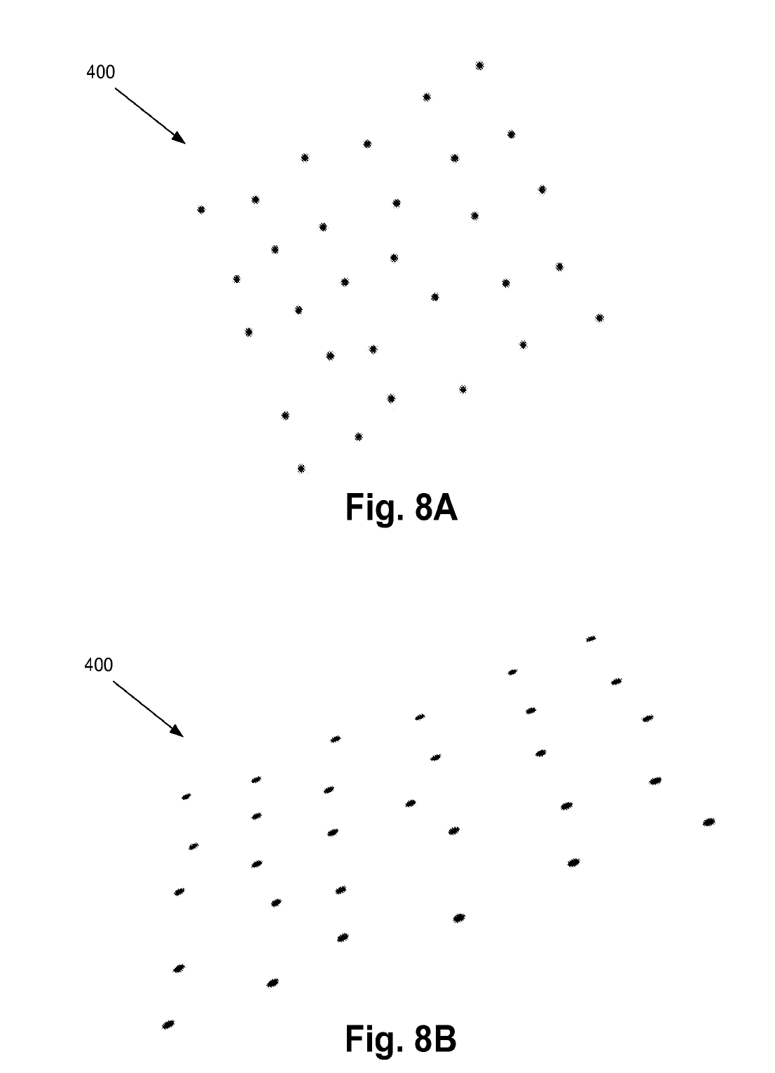

FIG. 4 illustrates an exploded perspective view of layers of the mobile unit 200. As shown in FIG. 8, the body 210 can comprise two or more connectable components for housing the receiving surface 220. The components of the body 210 can include a frame 212 and a backing 216.

The receiving surface 220 can be a surface of a panel 222 secured within the body 210. In some embodiments, the panel 222 can be a whiteboard, and the receiving surface 220 can be the writing surface of whiteboard. As shown, the panel 222 can comprise a ceramic layer 224 and a ruggedizing layer 226. The ruggedizing layer 226 can be a rugged, sturdy material, such as steel. The panel 222 can be secured between the frame 212 and the backing 216 of the body 210. The frame 212 can define an opening 215, and the receiving surface 220 can be accessible through such opening 215. In an exemplary embodiment, an accessible portion of the receiving surface 220 is approximately 8.5 by 11 inches.

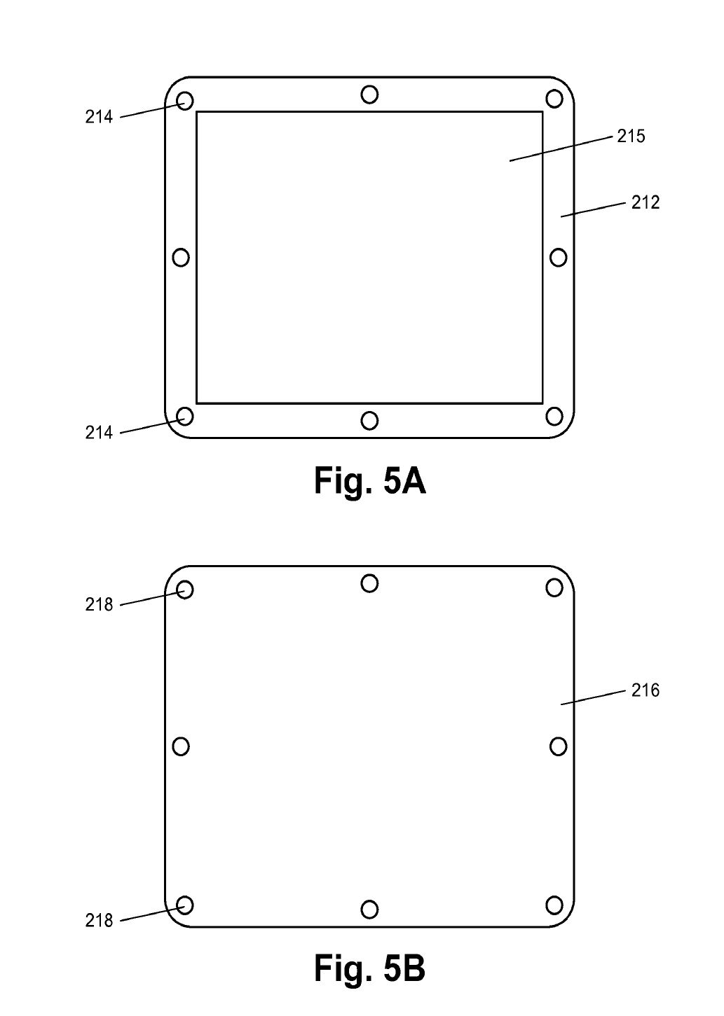

As illustrated in FIGS. 5A-5B, the frame 212 and the backing 216 can comprise a plurality of connectors 214 and 218. The frame connectors 214 can be complimentary to the backing connectors 218. The frame 212 and the backing 216 can be secured together by securing each frame connector 214 to a corresponding backing connector 218. Such connectors 214 and 218 can be of various types. For example, the backing connectors 218 can be screws, while the frame connectors 214 are receivers for the screws. Alternatively, the frame 212 and the backing 216 can be snap-fitted. In that case, the connectors 214 and 218 can be molded to snap together.

In assembling the mobile unit 200, the panel 222 can be placed between the frame 212 and the backing 216 before securing the frame 212 to the backing 216.

Additionally, one or more magnets 250 can be connected to the backing 216. The magnets 250 can be positioned on, or in proximity to, a rear face of the backing 216. The magnets 250 can provide convenient storage of the mobile unit 200. For example, the mobile unit 200 can be stuck to the display surface 110 for storage, if the display surface 110 is made of ceramic-steel or other conductive material.

### C. The Input Device

The input device 300 can be used with the mobile unit 200 or directly on the display surface 110 to modify the display image 115 on the display surface 110. Throughout the following description, the input device 300 is described in the context of its use with the mobile unit 200. The input device 300, however, need not be exclusively tied to either the mobile unit 200 or the display surface 110, and can switch back and forth between the two. In some exemplary embodiments, multiple input devices 300 can be used simultaneously with the display surface 110, with a single mobile unit 200, or with a combination of the display surface 110 and one or more mobile units 200. To facilitate the use of multiple input devices 300 simultaneously, each input device 300 can have a unique identifier that the input device 300 transmits to the processing device 120 when transmitting user interaction data. Additionally, in some embodiments of the display system 100, a single input device 300 can be switched back and forth between a mobile unit 200 and the display surface 110 even within a single user session with the display system 100.

In some exemplary embodiments, the display system 100 can require indication of whether the input device 300 is performing on the display surface 110 or the mobile unit 200. For example, the input device 300 can provide a switch, button, or other actuator for indicating to the display system 100 whether the input device 300 is currently configured to operate on the display surface 110 or the mobile unit 200. In other exemplary embodiments, however, the input device 300 can recognize the surface on which it operates, such as by recognizing the particular dot pattern 400 used on the surface, and no indication need be provided to the display system 100.

Because the display surface 110 and the receiving surface 220 of the mobile unit 200 have similar properties, such as incorporating a pattern 400 or other indication of coordinates, the effect of using the input device 300 directly on the display surface 110 is the same or similar to the effect of using the input device 300 on the receiving surface 220 of the mobile unit 200. In either case, use of the input device 300 can be translated into operations on the display image 115, which can be projected onto the display surface 110 to modify the display image 115 in accordance with the operations. Thus, although the following description refers to use of the input device 300 with the receiving surface 220 of the mobile unit 200, the following description also applies to use of the input device 300 directly with the display surface 110.

The input device 300 can be activated by many means, such as a switch, button, or other actuator, or by bringing the input device 300 in sufficient proximity to the surface 110. While activated, placement or movement of the input device 300 in contact with, or in proximity to, the receiving surface 220 of the mobile unit 200 can indicate to the processing device 120 that certain operations are to occur on the display image 115. For example, when the input device 300 contacts the receiving surface 220, the input device 300 can transmit coordinates of the input device 300 on the receiving surface 220 to the processing device 120. Accordingly, the display system 100 can cause an operation to be performed at corresponding coordinates of the display image 115 on the display surface 110. For example and not limitation, markings can be generated corresponding to a path of the input device 300, or the input device 300 can direct a cursor across the display surface 110.

Through interacting with the receiving surface 220, the input device 300 can generate digital markings on the display surface 110. In some embodiments, the input device 300 can also generate physical markings on the receiving surface 220. For example, when the input device 300 moves across the receiving surface 220, the input device 300 can leave physical markings, such as dry-erase ink, in its path. The receiving surface 220 can be adapted to receive such physical markings. Additionally, movement of the input device 300 can be analyzed to create a digital representation of such markings. These digital representations can be displayed on the display surface 110 by modification of the display image 115. The digital markings can also be stored by the electronic display system 100 for later recall, such as for emailing, printing, or future display.

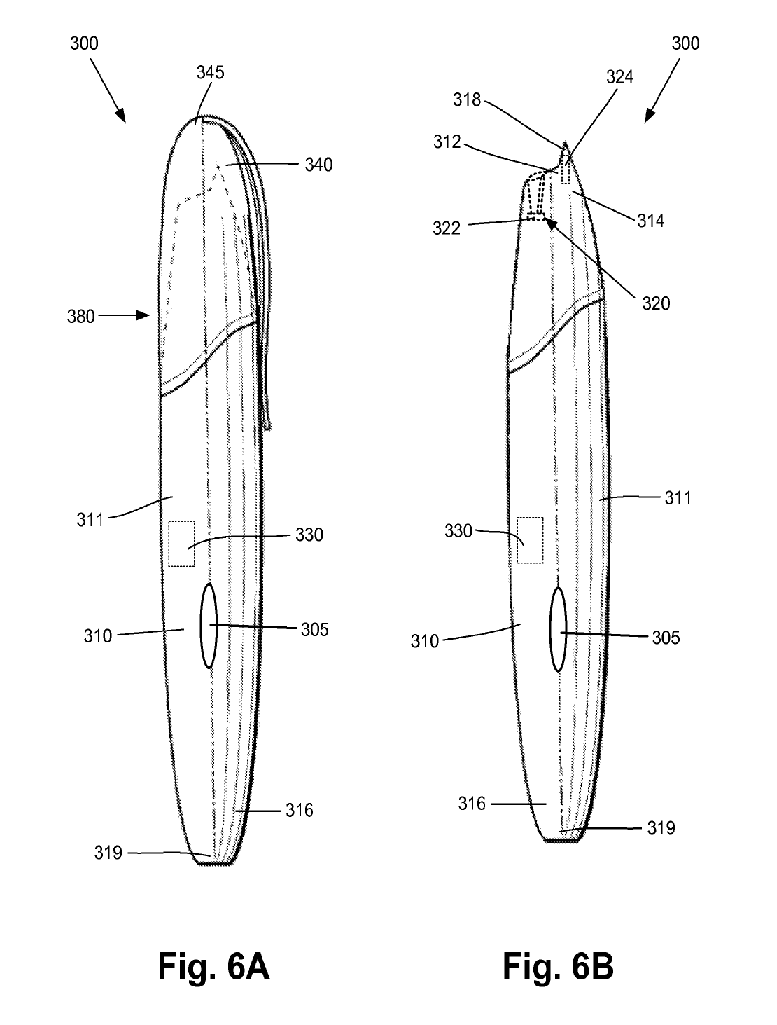

FIGS. 6A-6B illustrate partial cross-sectional side views of the input device 300. The input device 300 can comprise a body 310, a nib 318, a sensing system 320, a communication system 330, and a cap 340. FIG. 6A illustrates the input device 300 with the cap 340 secured to the body 310 of the input device 300. FIG. 6B illustrates the input device 300 without the cap 340.

The body 310 can provide structural support for the input device 300. The body 310 can comprise a shell 311, as shown, to house inner-workings of the input device 300, or alternatively, the body 310 can comprise a primarily solid member for carrying components of the input device 300. The body 310 can be composed of many materials. For example, the body 310 can be plastic, metal, resin, or a combination thereof, or many materials that provide protection to the components or the overall structure of the input device 300. The body 310 can further include a metal compartment for electrically shielding some or all of the sensitive electronic components of the device. The input device 300 can have many of shapes consistent with its use. For example, the input device 300 can have an elongated shape, similar to the shape of a conventional writing instrument, such as a pen, or a thicker design, such as a dry-erase marker.

The body 310 can comprise a first end portion 312, which is a head 314 of the body 310, and a second end portion 316, which is a tail 319 of the body 310. At least a portion of the head 314 can be interactable with the receiving surface 220 during operation of the input device 300.

The nib 318 can be positioned at the tip of the head 314 of the input device 300, and can be adapted to be placed in proximity to, contact, or otherwise indicate, a point on the receiving surface 220. For example, as a user writes with the input device 300 on the receiving surface 220, the nib 318 can contact the receiving surface 220 as the tip of a pen would contact a piece of paper. While contact with the receiving surface 220 may provide for a comfortable similarity to writing with a conventional pen and paper, or whiteboard and dry-erase marker, contact of the nib 318 to the receiving surface 220 need not be required for operation of the input device 300. For example, once the input device 300 is activated, the user can place the input device 300 in sufficient proximity to the receiving surface 220, or the user can point from a distance, as with a laser pointer. The nib 318 can comprise a marking tip, such as the tip of a dry-erase marker or pen. As a result, contact of the nib 318 to the receiving surface 220 can result in physical marking of the receiving surface 220.

The sensing system 320 can be coupled to, and in communication with, the body 310. The sensing system 320 can be adapted to sense indicia of the posture of the input device 300 relative to the receiving surface 220. The posture of the input device 300 can include, for example the distance of the input device 300 from the receiving surface 220, and the roll, tilt, and yaw of the input device 300 with respect to the receiving surface 220. From the posture of the input device 300, the specific point on the receiving surface 220 toward which the input device 300 is aimed or directed can be determined. As the input device 300 interacts with the receiving surface 220, such as by moving across the receiving surface 220, the sensing system 300 can periodically or continuously gather data relating to the posture of the input device 300. That data can be utilized to update the display image 115 on the display surface 110.

The input device 300 has six degrees of potential movement, which can result in various detectable postures of the input device 300. In the two-dimensional coordinate system of the receiving surface 220, the input device 300 can move in the horizontal and vertical directions. The input device 300 can also move normal to the receiving surface 220, and can rotate about the horizontal, vertical, and normal axes. These rotations are commonly referred to, respectively, as the roll, yaw, and tilt of the input device 300. The sensing system 320 can sense many combinations of these six degrees of movement.

The term “tipping” as used herein, refers to angling of the input device 300 away from normal to the receiving surface 220, and, therefore, includes rotations about the horizontal and vertical axes, i.e., the roll and the yaw of the input device 300. On the other hand, “orientation,” as used herein, refers to rotation parallel to the plane of the receiving surface 220 and, therefore, about the normal axis, i.e., the tilt of the input device 300.

The sensing system 320 can have many implementations adapted to sense indicia of the posture of the input device 300 with respect to the receiving surface 220. As shown, for example, the sensing system can include a first sensing device 322 and a second sensing device 324. Each sensing device 322 and 324 can be adapted to sense indicia of the posture of the input device 300. Further, each sensing device 322 and 324 can individually detect data for determining the posture of the input device 300 or, alternatively, can detect such data in conjunction with other components, such as another sensing device.

The first sensing device 322 can be a surface sensing device for sensing the posture of the input device 300 based on properties of the receiving surface 220. The surface sensing device 322 can be, or can comprise, a camera. The surface sensing device 322 can detect portions of the position-coding pattern 400 on the receiving surface 220. Detection by the surface sensing device 322 can comprise viewing, or capturing an image of, a portion of the pattern 400.

Additionally or alternatively, the sensing system 320 can comprise an optical sensor, such as that conventionally used in an optical mouse. In that case, the sensing system 320 can comprise light-emitting diodes and photodiodes, or a CMOS camera, to detect movement relative to the receiving surface 220.

The surface sensing device 322 can be in communication with the body 310 of the input device 300, and can have many positions and orientations with respect to the body 310. For example, the surface sensing device 322 can be housed in the head 314, as shown. Additionally or alternatively, the surface sensing device 322 can be positioned on, or housed in, many other portions of the body 310.

The second sensing device 324 can be a contact sensor. The contact sensor 324 can sense when the input device 300 contacts a surface, such as the receiving surface 220. The contact sensor 324 can be in communication with the body 310 and, additionally, with the nib 318. The contact sensor 324 can comprise, for example and not limitation, a switch that closes a circuit when a portion of the input device 300, such as the nib 318 contacts a surface with predetermined pressure. Accordingly, when the input device 300 contacts the receiving surface 220, the display system 100 can determine that an operation is indicated.

To facilitate analysis of data sensed by the sensing system 320, the input device 300 can further include a communication system 330 adapted to transmit information to the processing device 120 and to receive information from the processing device 120. For example, if processing of sensed data is conducted by the processing device 120, the communication system 330 can transfer sensed data to the processing device 120 for such processing. The communication system 330 can comprise, for example, a transmitter, a receiver, or a transceiver. Many wired or wireless technologies can be implemented by the communication system 330. For example, the communication system 330 can implement Bluetooth or 802.11b technology.

The cap 340 can be releasably securable to the head 314 of the body 310 to cover the nib 318. The cap 340 can be adapted to protect the nib 318 and components of the input device 300 proximate the head 314, such as the surface sensing device 322.

The input device 300 can have two or more states. A current state of the input device 300 can be defined by a position of the cap 340. For example, the input device 300 can have a cap-on state, in which the cap 340 is secured over the nib 318, and a cap-off state, in which the cap 340 is not secured over the nib 318. The cap 340 can also be securable over the tail 319, but such securing over the tail 319 need not result in a cap-on state.

The input device 300 can detect presence of the cap 340 over the nib 318 in many ways. For instance, the cap 340 can include electrical contacts that interface with corresponding contacts on the body 310, or the cap 340 can include geometric features that engage a detonate switch of the body 310. Also, presence of the cap 340 can be indicated manually or detected by a cap sensor 342 (see FIG. 7A), by distance of the nib 318 from the receiving surface 220, or by the surface sensing device 322.

The user can manually indicate to the whiteboard system that the input device 300 is in a cap-on state. For example, the input device can comprise an actuator 305, such as a button or switch, for the user to actuate to indicate to the display system 100 that the input device 300 is in a cap-on or, alternatively, a cap-off state.

FIG. 7A illustrates a close-up cross-sectional side view of the head 314 of the input device 300. As shown in FIG. 7A, the input device 300 can comprise a cap sensor 342. The cap sensor 342 can comprise, for example, a pressure switch, such that when the cap 340 is secured over the nib 318, the switch closes a circuit, thereby indicating that the cap 340 is secured. Further, the cap sensor 342 can be a pressure sensor and can sense when the cap is on and contacting a surface, such as the receiving surface 220. A first degree of pressure at the cap sensor 342 can indicate presence of the cap 340 over the nib 318, while a higher degree of pressure can indicate that the cap is on and in contact with, or pressing against, a surface. The cap sensor 342 can be positioned in the body 310, as shown, or in the cap 340.

Whether the input device 300 is in the cap-on state can be further determined from the distance of the nib 318 to the receiving surface 220. When the cap 340 is removed, the nib is able to contact the receiving surface 220, but when the cap 340 is in place, the nib 318 cannot reach the receiving surface 220 because the cap 340 obstructs such contact. Accordingly, when the nib 318 contacts the receiving surface 220, it can be determined that the cap 340 is off. Further, there can exist a predetermined threshold distance D, such that, when the nib 318 is within the threshold distance D from the receiving surface, the input device 300 is determined to be in a cap-off state. On the other hand, if the nib 318 is outside of the threshold distance D, the cap may be secured over the nib 318.

Additionally or alternatively, the surface sensing device 322 can detect the presence or absence of the cap 340 over the nib 318. When secured over the nib 318, the cap 340 can be within the range, or field of view FOV, of the surface sensing device 322. Therefore, the surface sensing device can sense the cap 340 when the cap 340 is over the nib 318, and the display system 100 can respond accordingly.

A mode-indicating system 370 of the input device 300 can incorporate the cap 340. For example, one or more states of the input device 300, such as cap-on and cap-off states, can correspond to one or more operating modes of the input device 300. In other words, changing the position of the cap 340 can indicate to the display system 100 that the operating mode has changed. Preferably, there is a one-to-one correspondence between states of the input device 300 and operating modes of the input device 300. The input device 300 can have many operating modes, including, without limitation, a marking mode and a pointing mode.

In the marking mode, the input device 300 can digitally mark the display surface 110. For example, movement of the input device 300 across the receiving surface 220 can be interpreted as writing or drawing on the display surface 110. In response to such movement, digital writing or drawing can be displayed on the display surface 110. In the pointing mode, the input device 300 can perform in a manner similar to that of a computer mouse. The input device 300 can, for example, drive a graphical user interface, or direct a on the display surface 110 to move and select displayed elements for operation.

Various means can be employed to power the input device 300 on and off. For example, in addition, or alternatively, to determining an operating mode, the state of the cap can determine whether the input device 300 is in use. For example, a determination that the cap 340 is on the input device 300 can indicate that the input device 300 is not in use. Accordingly, the input device 300 can automatically power off or otherwise decrease its power usage. Such a feature can save battery power and reduce or prevent accidental modification of the display image 115. In some exemplary embodiments, the input device 300 can comprise a power actuator 380, such as a switch, that is not directly associated with the cap 340. The power switch 380 can be used to power the input device 300 on and off regardless of the state of the cap 340.

Referring now back to FIGS. 6A-6B, if the surface sensing device 322 is housed in, or proximate, the head 314, it is desirable that the cap 340 not obstruct sensing when the cap 340 is secured over the nib 318. To facilitate sensing of indicia of the posture of the input device 300 when the cap 340 is secured over the nib 318, the cap 340 can comprise a translucent or transparent portion 345.

Alternatively, the surface sensing device 322 can be positioned such that the receiving surface 220 is visible to the surface sensing device 322 regardless is whether the cap 340 is secured over the nib 318. For example, the surface sensing device 322 can be carried by the body 310 at a position not coverable by the cap 340, such as at position 328 in FIG. 7A.

FIG. 7B illustrates another embodiment of the input device. As shown in FIG. 7B, in addition to the above features, the input device can further comprise a marking cartridge 350, an internal processing unit 355, memory 360, a power supply 365, or a combination thereof. The various components can be electrically coupled as necessary.

The input device 300 can be or comprise a pen or marker and can, thus, include a marking cartridge 350 enabling the input device 300 to physically mark the receiving surface 220. The marking cartridge 350, or ink cartridge or ink well, can contain a removable ink, such as conventional dry-erase ink. The marking cartridge 350 can provide a comfortable, familiar medium for generating handwritten strokes while movement of the input device 300 generates digital markings.

The internal processing unit 355 can be adapted to calculate the posture of the input device 300 from data received by the sensing system 320, including determining the relative or absolute position of the input device 300 in the coordinate system of the receiving surface 220. The internal processing unit 355 can also execute instructions for the input device 300. The internal processing unit 355 can comprise many processors capable of performing functions associated with various aspects of the invention.

The internal processing unit 355 can process data detected by the sensing system 320. Such processing can result in determination of, for example: distance of the input device 300 from the receiving surface 220; position of the input device 300 in the coordinate system of the receiving surface 220; roll, tilt, and yaw of the input device 300 with respect to the receiving surface 220, and, accordingly, tipping and orientation of the input device 300.

The memory 360 can comprise RAM, ROM, or many types of memory devices adapted to store data or software for controlling the input device 300 or for processing data.

The power supply 365 can provide power to the input device 300. The power supply 365 can be incorporated into the input device 300 in any number of locations. If the power supply 365 is replaceable, such as one or more batteries, the power supply 365 is preferably positioned for easy access to facilitate removal and replacement of the power supply 365. Alternatively, the input device 300 can be coupled to alternate power supplies, such as an adapter for electrically coupling the input device 300 to a car battery, a wall outlet, a computer, or many other power supplies.

Referring back to the cap 340, the cap 340 can comprise various shapes, such as the curved shape depicted in FIG. 7B or the faceted shape of FIG. 7A. The shape of the cap 340, however, is preferably adapted to protect the nib 318 of the input device 300.

As illustrated in FIG. 7B, the cap 340 can comprise a stylus tip 348. The stylus tip 348 of the cap 340 can be interactable with the receiving surface 220. When the stylus tip 348 contacts or comes in proximity to the receiving surface 220, the input device can operate on the display image 115, for example, by directing a cursor across the display image 115.

Multiple caps 340 can be provided, and securing of each cap 340 over the nib 318 can result in a distinct state of the input device 300. Further, in addition to indicating a change in operating mode of the input device 300, a cap 340 can provide additional functionality to the input device 300. For example, the cap 340 can provide one or more lenses, which can alter the focal length of the surface sensing device 322. In another example, the cap 340 can be equipped with a metal tip, such as the stylus tip 348, for facilitating resistive sensing, such that the input device 300 can be used with a touch-sensitive device.

As shown, the surface sensing device 322 need not be coverable by the cap 340. Placement of the surface sensing device 322 outside of the range of the cap 340 can allow for more accurate detection of the receiving surface 220. Further, such placement of the surface sensing device 322 results in the cap 340 providing a lesser obstruction to the surface sensing device 322 when the cap 340 is secured over the nib 318.

Referring back to the sensing system 320, the contact sensor 324, if provided, can detect when a particular portion of the input device 300, such as the nib 318, contacts a surface, such as the receiving surface 220. The contact sensor 324 can be a contact switch, such that when the nib 318 contacts the receiving surface 220, a circuit closes, indicating that the input device 300 is in contact with the receiving surface 220. The contact sensor 324 can also be a force sensor, which can detect whether the input device 300 presses against the receiving surface 220 with a light force or a hard force. The display system 100 can react differently based on the degree of force used. If the force is below a certain threshold, the display system 100 can, for example, recognize that the input device drives a cursor. On the other hand, when the force is above a certain threshold, which can occur when the user presses the input device 300 to the board, the display system 100 can register a selection, similar to a mouse click. Further, the display system 100 can vary the width of markings generated by the input device 300 based on the degree of force with which the input device 300 contacts the receiving surface 220.

Additionally, the surface sensing device 322 can include, for example, a complementary metal oxide semiconductor (CMOS) image sensor, a charge-coupled device (CCD) image sensor, or many other types of sensors for receiving image information. The surface sensing device 322 can be a CMOS or CCD image-sensor array having a size of, for example, 128 by 100, 128 by 128, or larger. The sensing system 320 enables the input device 300 to generate digital markings by detecting posture and movement of the input device 300 with respect to the receiving surface 220. For example and not limitation, the surface sensing device 322 can capture images of the receiving surface 220 as the pen is moved, and through image analysis, the display system 100 can detect the posture and movement of the input device 300.

Determining or identifying a point on the receiving surface 220 indicated by the input device 300 can require determining the overall posture of the input device 300. The posture of the input device 300 can include the position, orientation, tipping, or a combination thereof, of the input device 300 with respect to the receiving surface 220. When the input device 300 is in contact with the receiving surface 220, it may be sufficient to determine only the position of the input device 300 in the coordinate system of the receiving surface 220. In contrast, if the input device 300 is slightly removed from, and pointing at, the receiving surface 220, the orientation and tipping of the input device 300 can be required to determine the indicated point on the receiving surface 220.

As such, various detection systems can be provided in the input device 300 for detecting the posture of the input device 300. For example, a tipping detection system 390 can be provided in the input device 300 to detect the angle and direction at which the input device 300 is tipped with respect to the receiving surface 220. An orientation detection system 392 can be implemented to detect rotation of the input device 300 in the coordinate system of the receiving surface 220. Additionally, a distance detection system 394 can be provided to detect the distance of the input device 300 from the receiving surface 220.

These detection systems 390, 392, and 194 can be incorporated into the sensing system 320. For example, the position, tipping, orientation, and distance of the input device 300 with respect to the receiving surface 220 can be determined, respectively, by the position, skew, rotation, and size of the appearance of the pattern 400 on the receiving surface 220, as viewed from the surface sensing device 322. For example, FIGS. 2 and 8A-8B illustrate various views of an exemplary dot pattern 400 on the receiving surface 220. The dot pattern 400 serves as a position-coding pattern in the display system 100.

As discussed above, FIG. 2 illustrates an image of a pattern 400 on an exemplary receiving surface 220 of the mobile unit 200. In this case, the pattern 400 is a dot pattern. Dot patterns 400 can be designed to provide indication of an absolute position in a coordinate system of the receiving surface 220. In the image of FIG. 2, the dot pattern 400 is viewed at an angle normal to the receiving surface 220. This is how the dot pattern 400 could appear from the surface sensing device 322, when the surface sensing device 322 is directed normal to the receiving surface 220. In the image, the dot pattern 400 appears in an upright orientation and not angled away from the surface sensing device 322. As such, when the surface sensing device 322 captures such an image, the display system 100 can determine that the input device 300 is normal to the receiving surface 220 and, therefore, points approximately directly into the receiving surface 220.

As the input device 300 moves away from the receiving surface 220, the size of the dots, as well as the distance between the dots, in the captured image decreases. Analogously, as the input device 300 moves toward the receiving surface 220, the size of the dots, along with the distance between the dots, appears to increase. As such, in addition to sensing the tipping and orientation of the input device 300, the surface sensing device 322 can sense the distance of the input device 300 from the receiving surface 220.

FIG. 8A illustrates a rotated image of the dot pattern 400 of FIG. 2. A rotated dot pattern 400 indicates that the input device 300 is rotated about a normal axis of the receiving surface 220. For example, when a captured image depicts the dot pattern 400 rotated at an angle of 30 degrees clockwise, it can be determined that the input device 300 is oriented at an angle of 30 degrees counter-clockwise. As with the image of FIG. 2, this image was taken with the surface sensing device 322 oriented normal to the receiving surface 220, so even though the input device 300 is rotated, the input device 300 still points approximately directly into the receiving surface 220.

FIG. 8B illustrates a third image of the dot pattern 400 as viewed by the surface sensing device 322. The flattened image, depicting dots angled away from the surface sensing device 322, indicates that the surface sensing device 322 is not normal to the receiving surface 220. Further, the rotation of the dot pattern 400 indicates that the input device 300 is rotated about the normal axis of the receiving surface 220 as well. The image can be analyzed to determine the tipping angle and direction as well as the orientation angle. For example, it may be determined that the input device 300 is tipped downward 45 degrees, and then rotated 35 degrees. These angles determine to which point on the receiving surface 220 the input device 300 is directed.

Accordingly, by determining the angles at which an image received from the surface sensing device 322 was captured, the display system 100 can identify points at which the input device 300 interacts with the display surface 110, the receiving surface 220 of the mobile unit 200, or both.

### D. The Processing Device

Referring back to FIG. 1, the electronic display system 100 can include a processing device 120. Suitable processing devices 120 include a computing device 125, such as a personal computer. In some exemplary embodiments, the processing device 120 can be integrated with the display surface 110 into an electronic display device, or the processing device 120 can be integrated into the projector 130. Alternatively, however, as illustrated in FIG. 1, the processing device 120 can be separate from the display surface 110 and the projector 130.

The processing device 120 can be configured to receive position data relating to a posture of the input device 300 relative to a surface, and to map the position data to one or more operations on the display image 115. In some exemplary embodiments, such position data can comprise specific coordinates of the input device 300, which can be determined internally by the input device 300, such as by the input device's capturing and analyzing a position-coding pattern 400 on the surface. If this is not the case, however, the processing device 120 can analyze the received position data to determine one or more coordinates of the display surface 110 indicated by the input device 300. Such analysis can comprise image analysis to map image data, or other data indicative of the posture of the input device 300, to coordinates of the display surface 110.

In an exemplary embodiment of the display system 100, the input device 300 can be used with the mobile unit 200 or directly on the display surface 110. In either case, the processing device 120 can determine coordinates indicated on the display surface 110. If the input device 300 is used with the mobile unit 200, the determined coordinates on the display surface 110 can comprise a mapping of coordinates indicated on the receiving surface 220 of the mobile unit 200.

After the processing device 120 identifies target coordinates on the display surface 110, the processing device 120 can determine how to update an old image displayed on the display surface 110 based at least partially on the target coordinates and a current operating mode of the input device 300.

The processing device 120 can render a new display image 115 based on the old image, the target coordinates, and the current operating mode. The electronic display system 100 can then display the new image in place of the old image. In an exemplary embodiment of the electronic display system 100, the processing device 120 transmits the new image to the projector 130 for display onto the display surface 110.

### E. The Projector

If a projector 130 is utilized in the electronic display system 100, the projector 130 can be in communication with the processing device 120, such as by means of a wired or wireless connection, e.g., Bluetooth, or by many other means through which two devices can communicate. The projector 130 can project one or more display images onto the display surface 110 based on instructions from the processing device 120. For example and not limitation, the projector 130 can project a graphical user interface or markings created through use of the input device 300.

Like the processing device 120, the projector 130 can, but need not, be integrated with the display surface 110 into an electronic display device. Alternatively, the projector 130 can be excluded if the display surface 110 is otherwise internally capable of displaying markings and other objects on its surface 110. For example, the display surface 110 can be a surface of a computer monitor comprising a liquid crystal display.

### F. Use of the System

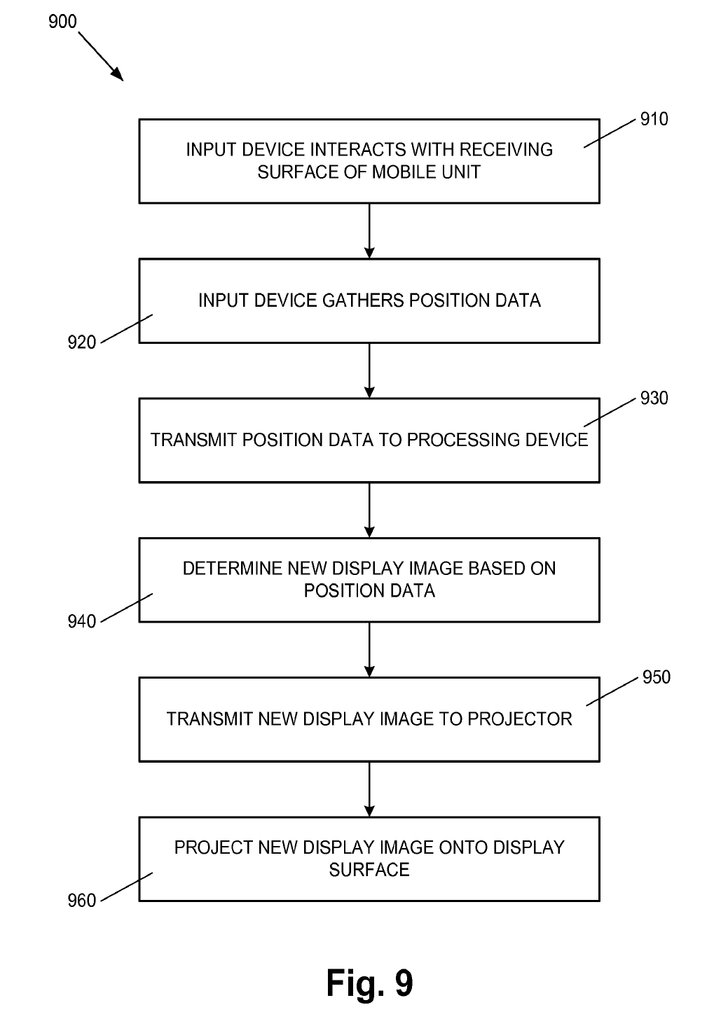

FIG. 9 illustrates a flow chart of a method 900 of modifying a display image 115 by receiving and processing data relating to use of the input device 300 with the mobile unit 200. As described above, an original display image 115 can be viewable on the display surface 110. Such display image 115 can include a projected image 113 communicated from the processing device 120 to the projector 130, and then projected onto the display surface 110.

In an exemplary embodiment, a user can operate on the display surface 110 by bringing a portion of the input device 300 in sufficient proximity to the receiving surface 220 of the mobile unit 200. In some embodiments, bringing a portion of the input device 300 in sufficient proximity to receiving surface 220 can require placing such portion of the input device 300 in contact with the receiving surface 220. At 910, the user can interact with the receiving surface 220, such as by moving the input device 300 across the receiving surface 220 while the input device 300 is in sufficient proximity to the receiving surface 220.

As the input device 300 travels along the receiving surface 220, at 920, the input device 300 can sense position data indicating the changing posture of the input device 300 with respect to the receiving surface 220. This data is then processed by the display system 100. In some embodiments of the display system 100, the internal processing unit 355 of the input device 300 processes the data. In other embodiments of the display system 100, as at 930, the data is transmitted, e.g., wirelessly, to the processing device 120 for processing. Processing of such data can result in determining the posture of the input device 300 and, therefore, can result in determining areas of the display surface 110 on which to operate. If processing occurs in the internal processing unit 355 of the input device 300, the results are transferred to the processing device 120 by the communication system 330.

At 940, the processing device 120 produces a revised projection image based on determination of the input mode and the posture of the input device 300. In marking mode, the revised projection image can incorporate a set of markings not previously displayed, but newly generated by the movement of the input device 300. In pointing mode, the revised projection image can incorporate, for example, updated placement of a cursor. The processing device can then transmit the revised projection image to the projector 130, at 950. At 960, the projector can project the revised projection image onto the display surface 110.

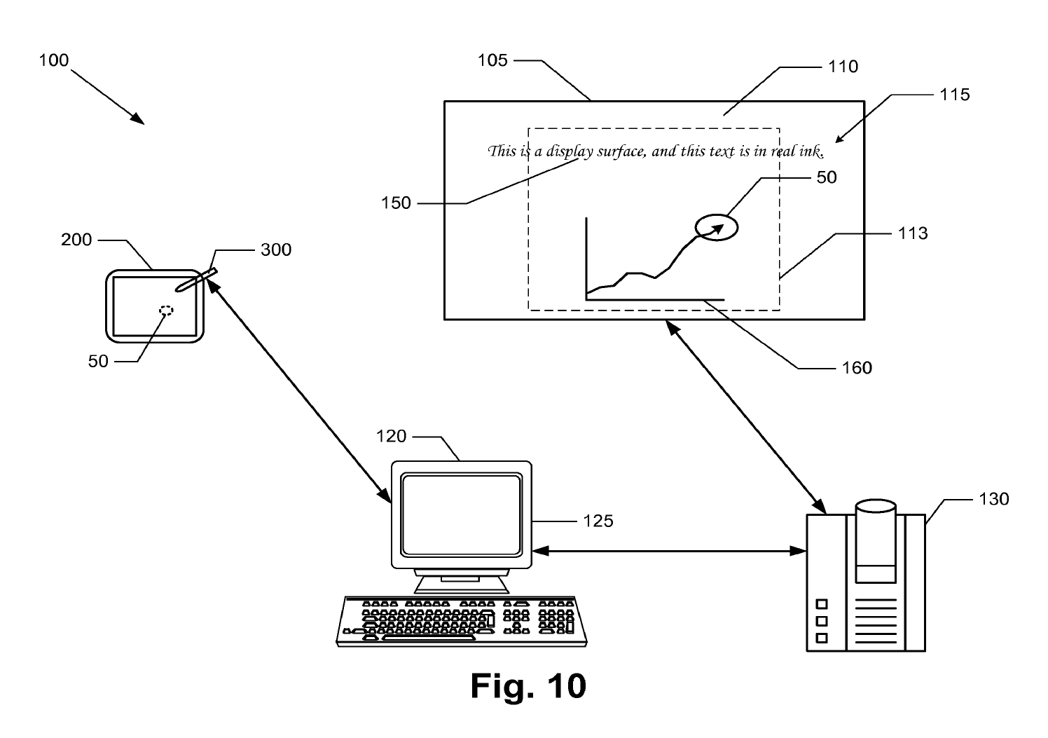

FIG. 10 illustrates a result of using the mobile unit 200 to create an object 50, such as a circle or ellipse, on the display surface 110. As shown in FIG. 10, creating the object 50 on the mobile unit 200 can cause the object 50 to appear on the display surface 110. As illustrated by the dotted outline of the object 50 in FIG. 10, although the object 50 appears on the display surface 110, the object 50 need not appear on the receiving surface 220 of the mobile unit 200.

Accordingly, operations and digital markings indicated by the input device 300 on the mobile unit 200 can be displayed on the display surface 110.

While the invention has been disclosed in exemplary forms, many modifications, additions, and deletions can be made without departing from the spirit and scope of the invention and its equivalents, as set forth in claims to be filed in a later non-provisional application.

1-75. (canceled)

76. A display system comprising:
a first mobile unit comprising:
a receiving surface for receiving a first user interaction at an interaction point on the receiving surface, the receiving surface having a plurality of points corresponding to a plurality of points in a display image external to the receiving surface, wherein coordinates of the interaction point on the receiving surface map to corresponding coordinates of an action point on the display image; and
a pattern on the receiving surface mapping to coordinates of the plurality of points on the receiving surface;
wherein the first user interaction at the interaction point on the receiving surface of the first mobile unit is translatable into a first operation at the action point on the display image; and
a second mobile unit configured to receive a second user interaction translatable into a second operation on the display image.

77. The display system of claim 76, the first mobile unit being absent internal electronics.

78. The display system of claim 76, further comprising a processing device configured to perform the first operation at the action point on the display image, in response to the first user interaction at the interaction point on the receiving surface of the first mobile unit.

79. (canceled)

80. The display system of claim 76, further comprising an input device configured to detect a portion of the pattern on the receiving surface of the first mobile unit.

81. (canceled)

82. (canceled)

83. (canceled)

84. (canceled)

85. The display system of claim 80, further comprising a processing device configured to determine the first operation to be performed at the action point on the display image, based at least partially on the detected portion of the pattern on the receiving surface of the first mobile unit.

86. The display system of claim 85, the processing device being distinct from the input device.

87. (canceled)

88. The display system of claim 76, further comprising a display surface configured to receive the display image, the display surface being remote from the mobile unit.

89. The display system of claim 88, the display surface being a whiteboard surface.

90. (canceled)

91. (canceled)

92. (canceled)

93. (canceled)

94. The display system of claim 88, further comprising a projector configured to project the display image onto the display surface.

95. The display system of claim 94, the display surface and the projector being integrated together into an electronic display surface.

96. A computer-implemented method comprising:
accessing coordinates of an interaction point of a user interaction performed on a receiving surface, the receiving surface being absent an electronic display, and the coordinates being determined based on analysis of a captured image of a position-coding pattern on the receiving surface;
mapping, with a computer processor, the interaction point on the receiving surface to an operational point on a display image that is remote from the receiving surface;
performing an operation at the operational point on the display image to update the display image, the operation corresponding to the user interaction at the interaction point of the receiving surface;
repeatedly updating the display image in real time in response to a plurality of additional user interactions performed on the receiving surface.

97. The method of claim 96, further comprising:
capturing the captured image of the position-coding pattern on the receiving surface, during the user interaction;
analyzing the captured image in response to the user interaction with the receiving surface; and
determining the coordinates of the interaction point based on the analysis of the captured image.

98. (canceled)

99. (canceled)

100. (canceled)

101. The method of claim 96, further comprising directing a projector to project the updated display image in place of the display image.

102-111. (canceled)

112. The display system of claim 76, the receiving surface of the first mobile unit being a whiteboard surface.

113. A display system comprising:
a mobile unit comprising:
a receiving surface for receiving a first user interaction translatable into an action on a display image remote from the receiving surface; and
a first position-coding pattern on the receiving surface, the first position-coding pattern being detectable by a first instrument for identifying an interaction point of the instrument on the receiving surface, wherein the interaction point maps to an action point on the display image; and
a display surface configured to receive the display image, the display surface having a second position-coding pattern detectable by a second instrument.

114. The display system of claim 112, the receiving surface of the first mobile unit being a whiteboard surface.

115. The display system of claim 112, the first position-coding pattern comprising a known image.

116. The display system of claim 112, the first position-coding pattern indicating absolute coordinates of the interaction point with respect to the receiving surface.

117. The display system of claim 112, the receiving surface being useable with an instrument configured to capture an image of a local portion of the first position-coding pattern, wherein the captured image indicates the interaction point on the receiving surface.

118. The display system of claim 112, wherein the second position-coding pattern on the display surface is further detectable by the first instrument.
